(19) United States
(12) Patent Application Publication
(10) Pub. No.: US 2009/0293614 A1
(43) Pub. Date: Dec. 3, 2009

(54) APPARATUS AND METHOD FOR DETERMINING THE CLOSING VELOCITY OF A VEHICLE DOOR

(75) Inventors: Tony J. Deschutter, St. Clair Shores, MI (US); Craig A. Rodriguez, Rochester Hills, MI (US); Nidamaluri S. Nagesh, Ann Arbor, MI (US); Daniel W. Doubleday, Clinton Township, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/129,890

(22) Filed: May 30, 2008

(51) Int. Cl. G01P 3/04; G01P 15/00

(52) U.S. Cl. 73/510; 73/488

(57) ABSTRACT

An apparatus for measuring a closing velocity of a door of a vehicle having a body is provided. The apparatus includes a base, a door-closing member, an actuator, and a sensor assembly. The door-closing member is movably coupled to the base. The actuator is coupled to the base and the door-closing member and is configured to move the door-closing member. The movement of the door-closing member causes the door of the vehicle to move relative to the body of the vehicle at a predetermined velocity. The sensor assembly is coupled to the base and configured to detect a position of the door of the vehicle relative to a selected portion of the vehicle and generate a signal representative thereof.

### TECHNICAL FIELD

Embodiments of the present invention generally relate to automobile testing equipment, and more particularly relate to instruments for determining the closing velocity of automobile doors.

### BACKGROUND

In recent years, advances in technology, as well as ever-evolving tastes in style, have led to substantial changes in the design of automobiles. Many of the changes involve the variety, complexity, and quality of the luxury and convenience features now found as standard equipment on many automobiles.

Some of the most frequently used features on automobiles are the doors, which allow occupants access to the automobile's cabin. Consumers have come to expect a particular feel of the operation of the doors, including the force required to close (and open) the doors. In particular, consumers expect the doors to close completely with only a moderate amount of force (or closing velocity). As such, manufacturers often test the force, or velocity (i.e., speed), required to completely close the doors (i.e., “door-closing velocity”) off-line in test or audit environments, in which only a small percentage of vehicles are test by trained personnel.

Accordingly, it is desirable to provide an automated apparatus for determining the closing velocity of the doors on a vehicle that verifies the velocity of the door and determines that the door has been closed completely. Furthermore, other desirable features and characteristics of the system described herein will become apparent from the subsequent detailed description and the appended claims, taken in conjunction with the accompanying drawings and the foregoing technical field and background.

### BRIEF SUMMARY

An apparatus for measuring a closing velocity of a door of a vehicle having a body is provided. The apparatus includes a base, a door-closing member, an actuator, and a sensor assembly. The door-closing member is movably coupled to the base. The actuator is coupled to the base and the door-closing member and is configured to move the door-closing member. The movement of the door-closing member causes the door of the vehicle to move relative to the body of the vehicle at a predetermined velocity. The sensor assembly is coupled to the base and configured to detect a position of the door of the vehicle relative to a selected portion of the vehicle and generate a signal representative thereof.

An apparatus for measuring a closing velocity of a door of a vehicle having a body is provided. The apparatus includes a base, a door-closing member, an actuator, a vehicle position sensor, a door position sensor, and a controller. The door-closing member is movably coupled to the base. The actuator is coupled to the base and the door-closing member and is configured to move the door-closing member. The vehicle position sensor assembly is coupled to the base and is configured to detect a position of the vehicle relative to the base and generate a signal representative thereof. The door position sensor assembly is coupled to the base and is configured to detect a position of the door of the vehicle relative to a selected portion of the vehicle and generate a signal representative thereof. The controller is in operable communication with the actuator, the vehicle sensor assembly, and the door position sensor assembly. The controller is configured to cause the actuator to move the door-closing member in response to the vehicle being in a first position relative to the base, the movement of the door-closing member causing the door of the vehicle to move at a predetermined velocity and generate an alert signal representative of the position of the door of the vehicle relative to the selected portion of the vehicle in response to the vehicle being in a second position relative to the base.

A method for measuring a closing velocity of a door of a vehicle having a body is provided. The vehicle is moved between first and second positions. A door-closing member is automatically actuated during the movement of the vehicle when the vehicle is in the first position. The actuation of the door-closing member causes the door of the vehicle to move relative to the body of the vehicle at a predetermined velocity. A position of the door of the vehicle relative to a selected portion of the vehicle is automatically detected during the movement of the vehicle when the vehicle is in the second position. A signal representative of the position of the door of vehicle relative to the selected portion of the vehicle is generated after the vehicle is moved into the second position.

### BRIEF DESCRIPTION OF THE DRAWINGS

The present invention will hereinafter be described in conjunction with the following drawing figures, wherein like numerals denote like elements, and

FIG. 1 is an isometric view of a door-closing velocity measuring apparatus according to one embodiment of the present invention;

FIG. 2 is an isometric view of a door-closing assembly within the apparatus of FIG. 1;

FIG. 3 is an isometric view of a velocity sensor array and a controller within the door-closing assembly of FIG. 2;

FIG. 4 is an isometric view of a door status sensor array within the apparatus of FIG. 1;

FIG. 5 is an isometric view of an automotive assembly line including the apparatus of FIG. 1 with a vehicle in a first position; and

FIG. 6 is an isometric view of the automotive assembly line of FIG. 5 with the vehicle in a second position.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

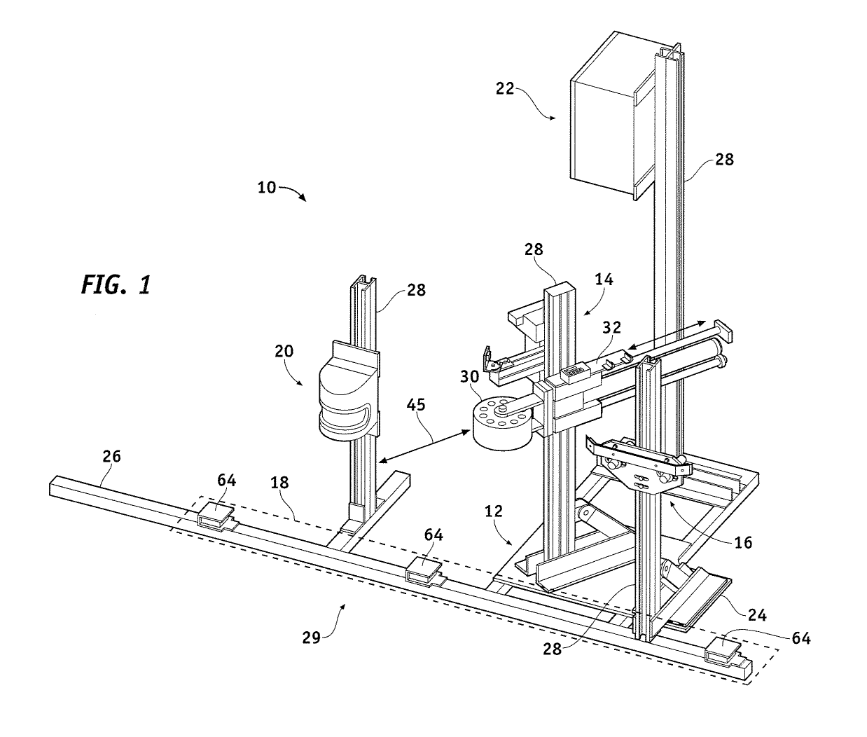

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment. It should also be understood that FIGS. 1-6 are merely illustrative and may not be drawn to scale.

The force required to close a vehicle door (i.e., “door-closing force”) varies based on a variety of factors such as door weight, hinge type, door size (i.e., dimensions), and location of door handle with respect to the pivot point of the hinge (i.e., when the handle is farther away, leverage is increased and the force required is reduced). Door-closing velocity (or speed), or the closing velocity of the door, may be more easily measured than force. The door-closing force may then be derived from the velocity measurement if necessary.

Further, a manufacturer of a wide range of vehicular products may chose to limit the variables that may play a significant role in determining the door-closing velocity (which correlates to door-closing force) by standardization. Despite the variation of door design by vehicle brand, design, or type, many of these vehicles may have doors with the same, or very similar, door-closing variables. As a result, a range of as few, for example, six standards for door-closing velocity may be sufficient to cover a wide range of vehicle brands and/or vehicle types. Accordingly, it may be convenient for an exemplary embodiment of a door-closing velocity measurement device to be configured for all or at least most of the range of door-closing standards of the manufacturer's product lines.

FIGS. 1-5 illustrate apparatuses and methods for measuring a closing velocity of a vehicle door. The apparatus includes a base, a door-closing member, an actuator, and a sensor assembly. The door-closing member is movably coupled to the base. The actuator is coupled to the base and the door-closing member and is configured to move the door-closing member. The movement of the door-closing member causes the door of the vehicle to move relative to a body of the vehicle at a predetermined velocity. The sensor assembly is coupled to the base and configured to detect a position of the door of the vehicle relative to a selected portion (e.g., the body or another door) of the vehicle and generate a signal representative thereof. Based on the position of the door relative to the selected portion of the vehicle, it may be determined whether or not the movement of the door-closing member (and/or the door) at the predetermined velocity caused the door to completely close.

FIG. 1 illustrates an apparatus (or system) 10 for measuring, determining, or testing, the closing velocity of a door on a vehicle, according to one embodiment of the present invention. The apparatus 10 includes a base (or frame) 12, a door-closing assembly 14, a door-status sensor assembly 16, a vehicle position sensor assembly 18, a system status sensor assembly 20, and a control system 22. In the depicted embodiment, the base 12 includes a platform 24, a rail 26, and multiple support posts 28. The rail 26 is connected to the platform 24 on a vehicle side 29 of the apparatus 10, as described in below. The support posts 28 are connected to and extend upwards from various positions on the base 12.

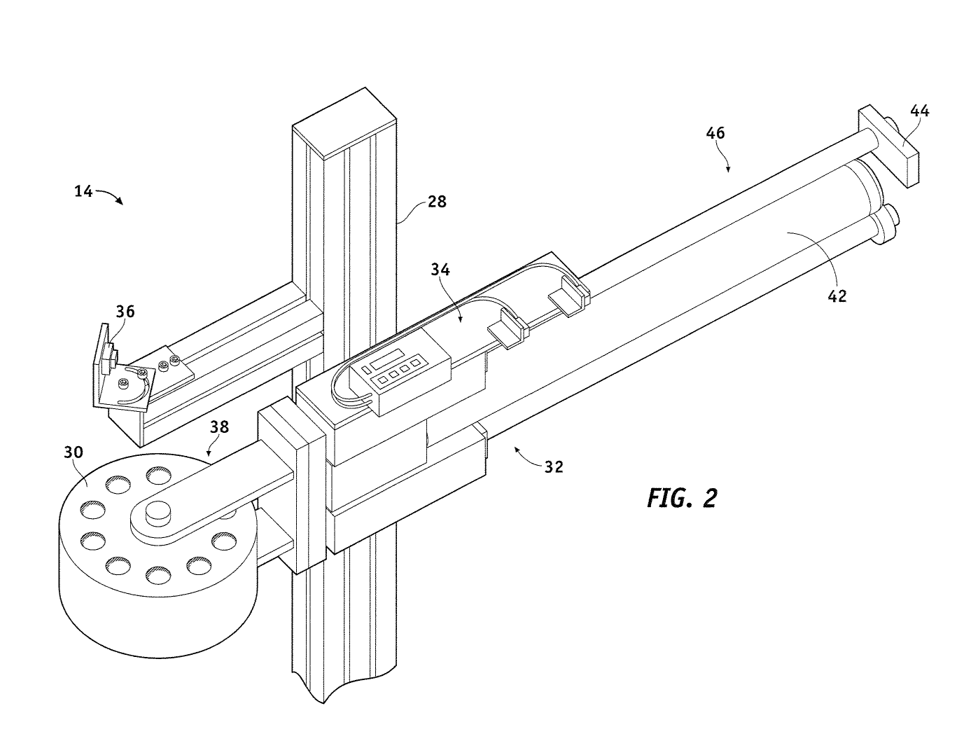

Referring to FIGS. 1 and 2, the door-closing assembly 14 is coupled to one of the support posts 28 and includes a door-closing member 30, an actuator 32, an actuator control system 34, and a door proximity sensor 36. In the depicted embodiment, the door-closing member 30 has a cylindrical, or wheel-like, shape, is made of a rubber or foam material, and is rotationally (or rotatably) coupled to a first end 38 of the actuator 32. As shown in FIGS. 1, 2, and 3, the actuator 32 is a linear actuator, such as a linear electric motor or pneumatic cylinder, and has a cylinder (i.e., a stator) 40 and a piston (i.e., rotor) 42, with a sensor flag 44 connected to a second end 46 of the actuator 32. The actuator 32 is operable to move, or actuate, the piston 42 such that the door-closing member 30 is movable between a retracted (or first) position (shown in FIGS. 1 and 2) and an extended (or second) position (as indicated in FIG. 1 by arrow 45).

The actuator control system 34 includes a controller 48 and two flag sensors 50 (or a velocity sensor array) on an upper side of the cylinder 40 of the actuator 32. The controller 48 includes a display device 52 and a user input interface 54 on a top side thereof. The display device 52 is, for example, a liquid crystal display (LCD) device, as is commonly understood, and the user input interface 54 includes buttons (or keys). The buttons may include, for example, a “clear” button that clears the display device 52, “scroll up” and “scroll down” buttons, respectively, to scroll or navigate through a menu displayed on the display device 52, and a “selection” button to select an item from the menu. The flag sensors 50 are spaced a distance 56 apart and, in one embodiment, are infrared sensors, as are commonly understood.

The door proximity sensor 36 is coupled to the respective support post 28 and positioned above the door-closing member 30 (in the retracted position). In one embodiment, the door proximity sensor 36 is an ultrasonic sensor, although other sensors may also be used, such as an infrared sensor. It should be understood that the door proximity sensor 36 may be understood to be a component of the vehicle position sensor assembly 18, as will be made clear below.

Although not shown in detail, the door-closing assembly 14 may be coupled to the base 12, via the respective support post 28, to be rotated and fixed in various angular orientations, as well as be adjusted to various heights above the base 12.

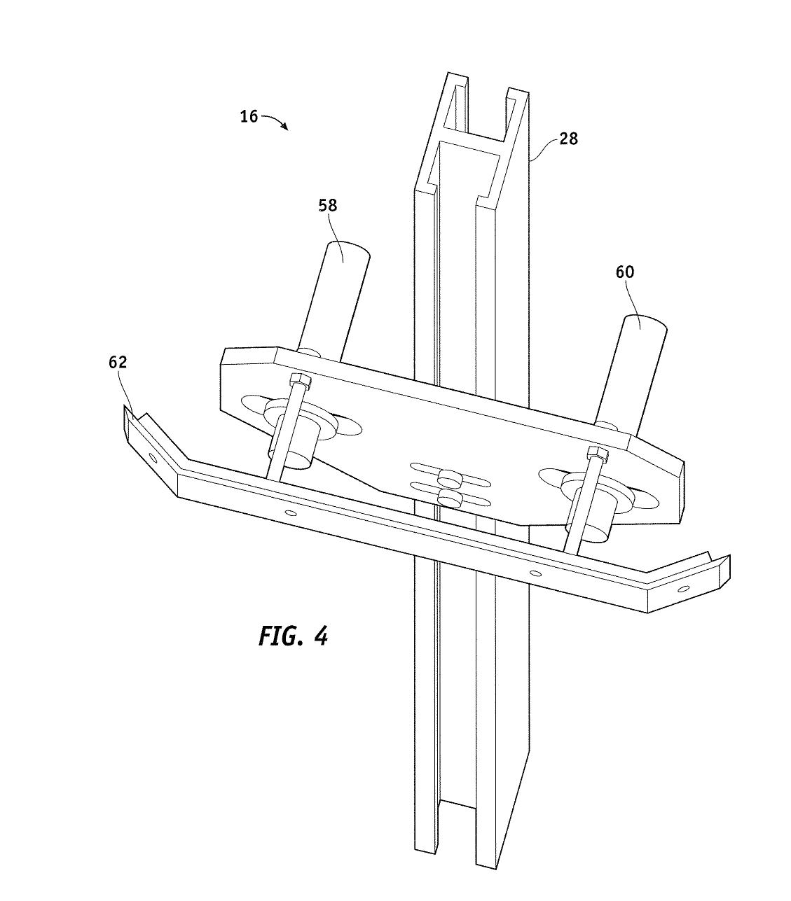

Referring to FIGS. 1 and 4, the door status sensor assembly 16 is coupled to one of the support posts 28 and includes a first door status sensor 58, a second door status sensor 60, and a protective washer 62. The first and second door status sensors 58 and 60 are coupled to the respective support post 28 in a spaced relationship and at substantially equal heights above the base 12. The protective washer 62 is attached to the respective support post 28 and, although not shown in detail, extends away from the post 28 (on the vehicle side thereof) farther than the first and second door status sensors 58 and 60. The door status sensor assembly 16 may be coupled to the respective support post 28 such that its height above the base 12 may be adjusted.

As shown in FIG. 1, the vehicle position sensor assembly 18 includes multiple vehicle position (or wheel) sensors 64 connected to and adjustably positioned along the rail 26. In one embodiment, the vehicle position sensors 64 are infrared sensors. The system status sensor assembly 20 may include various sensors, such as infrared and/or ultrasonic, and may be used to detect substantial variations on the test system described below, such as the presence of a large, unknown object, such as a person.

The control system 22 is secured to a respective support post 28. Although not shown, the control system 22 (and/or the actuator controller 48) includes a processor and a memory which may be in the form of integrated circuits formed on semiconductor substrates, as is commonly understood. The processor may be any one of numerous known general-purpose microprocessors or an application specific processor that operates in response to program instructions stored on a computer-readable medium (i.e., a memory). The memory may include random access memory (RAM) and/or read only memory (ROM), and the instructions stored thereon may include instructions for carrying out the methods and processes described below.

During operation, the door-closing assembly 14 is set such that the door-closing member 30 is moved from the retracted position to the extended position at a selected, predetermined velocity or speed. The predetermined speed is calibrated using the sensor flag 44 on the piston 42 and the two flag sensors 50. In particular, when the actuator 32 is operated, the piston 42 moves relative to the cylinder 40 towards the vehicle side 29 of the apparatus 10. As will be appreciated by one skilled in the art, the flag sensors 50 detect when their respective light beams are interrupted, or reflected, by the flag 44 passing within a known distance and generate electrical signals of such interruption. Based on the distance 56 between the flag sensors 50 and time between the interruptions of the beams, the actuator controller 48 calculates the speed of the piston 42, and thus the door-closing member 30. A vehicle door closed by the movement of the door-closing member 30 will be closed at the same speed as the movement of the piston 42 (i.e., the speed of the piston 42 relative to the vehicle).

The actuator controller 48 may have a clock that runs continuously such that as the flag 44 passes the first of the flag sensors 50, a signal from the sensor sets a first time (i.e., “start time”). Likewise, a signal from the second flag sensor 50 sets a second time (i.e., “stop time”). Alternatively, the controller 48 may have a timer (or “stop watch”) feature such that signals from the sensors 50 start and stop the stop watch, respectively. The actuator controller 48 uses the amount of time it takes from the flag 44 to pass between the two sensors 50 to adjust the speed of the movement of the piston 42 and/or the door-closing member 30. A user may use the user input interface 54 on the actuator controller 48 to set the speed to a desired level (e.g., based on the characteristics of a particular vehicle).

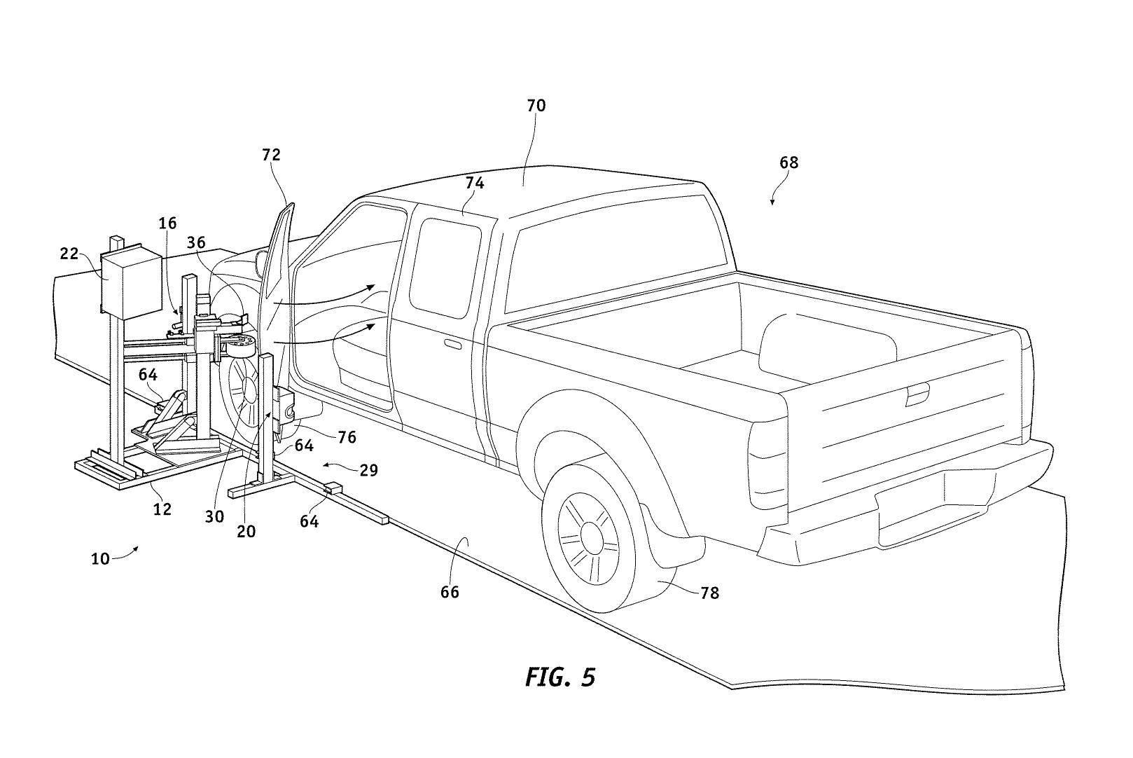

As shown in FIG. 5, the apparatus 10 is installed adjacent to (or as a component of) an automotive assembly line 66. Although not shown, it should be understood that the assembly line 66 may include numerous other components or machinery for assembling automobiles.

An automobile 68 is moved along the assembly line 66 on the vehicle side 29 of the apparatus 10. In the depicted embodiment, the automobile includes, amongst other components, a body 70, a forward-opening (or front) door 72, a rearward-opening (or rear) door 74, a front wheel (or wheels) 76, and a rear wheel (or wheels) 78.

Still referring to FIG. 5, as the automobile 68 is moved along the assembly line 66, it arrives at a first position relative to the base 12 of the apparatus 10, which is detected by the wheel sensors 64 as the wheels 76 and 78 of the automobile 68 pass thereby. In one scenario, as the automobile 68 enters the first position, the front door 72 is opened and the rear door 74 is closed, and the door-closing member 30 of the apparatus 10 is in the retracted position. The presence of the automobile 68 in the first position may also be detected by the door proximity sensor 36 detecting the front door 72 being within a predetermined distance, such as 30 millimeters (mm). When the automobile 68 in the first position, the control system activates the actuator 32 such that the door-closing member 30 is moved into the extended position at the pre-selected speed for the particular automobile 68 being tested, which causes the front door 72 to move (or swing) toward the body 70 of the automobile 68. This action may cause the front door 72 to completely close (e.g., a first door position). The two flag sensors 50 may be used to verify the closing speed during each actuation of the actuator 32.

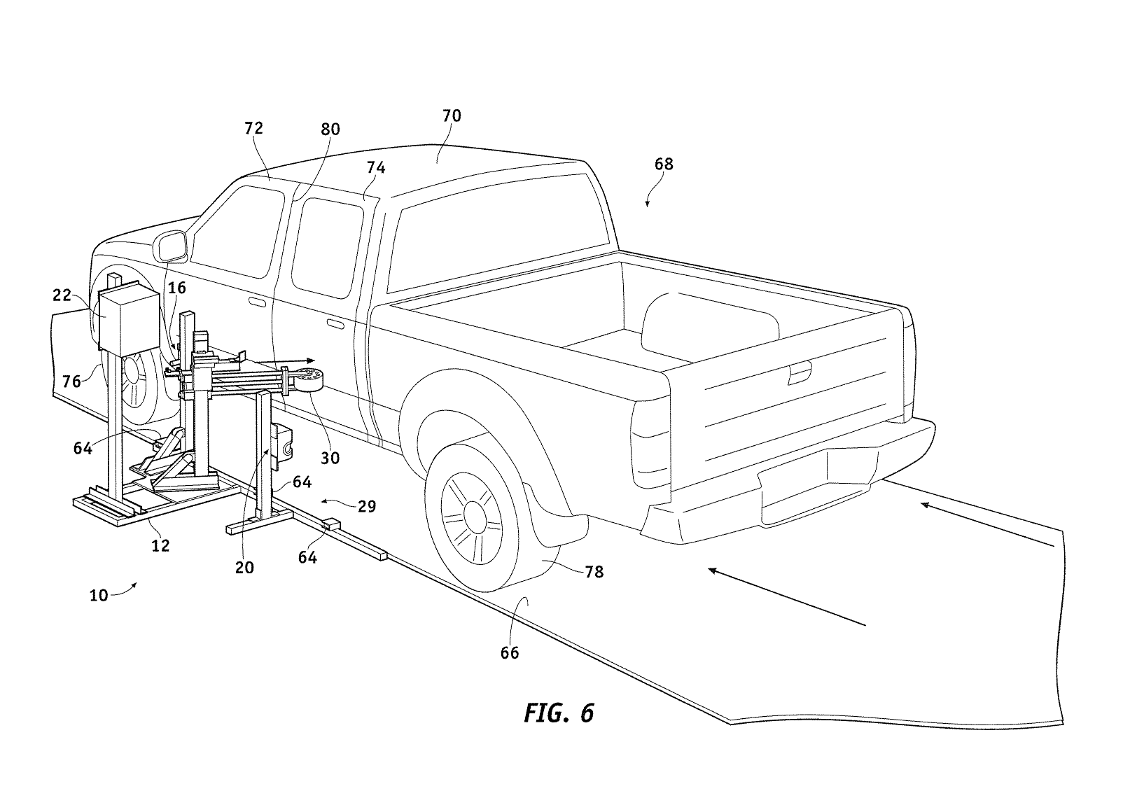

As shown in FIG. 6, the automobile 68 is then moved along the assembly line 66 to a second position relative to the base 12 of the apparatus 10, as detected by the wheel sensors 64. With automobile 68 in the second position, an end 80 of the front door 72 is positioned between the first and second door status sensors 58 and 60 (FIG. 4) of the door status sensor assembly 16 such that the rear door 74 (if closed), or another portion of the body 70 of the automobile 68, lies directly in front of the first door status sensor 58 and a portion of the front door (near the end 80) lies directly in front of the second door status sensor 60. In one embodiment, the automobile 68 is moved through the first and second positions at a substantially constant speed (i.e., without being stopped). In which case, the movement of the automobile 68 increases the velocity of the door-closing member 30, and thus the front door 72, relative to the body 70 of the automobile 68. This additional velocity may be taken into account when setting the speed of the actuator 32.

The control system 22 then activates the first and second door status sensors 58 and 60. The first door status sensor 58 measures (or detects) the distance between the door status sensor assembly 16, or sensor 58, and the rear door 74 (or the body 70 of the automobile 68). The second door status sensor 60 measures the distance between the door status sensor assembly 16, or sensor 60, and the front door 72. The door status sensors 58 and 60 generate signals representative of these distances which are received by the controller 48 which determines the offset between the doors 72 and 74. If this difference is above a predetermined threshold, the front door 72 is deemed not to be completely closed (e.g., a second door position), and the controller 48 sets a signal to indicate such. In one embodiment, the automobile 68 continues to move through the second position to another station of the assembly line 66 (not shown).

In the embodiment shown in which the first door status sensor 58 lies directly in front of the rear door 74, if the front door 72, as well as the rear door 74, is completely closed, the distances detected by the door status sensors 58 and 60 will be substantially the same (e.g., less than 5 mm). In which case, the controller 48 may be configured to generate a signal to indicate if the difference between the distances detected by the door status sensors 58 and 60 is relatively small, such as 5 mm or more.

Still referring to FIG. 5, as the automobile 68 is moved into the first position, if the system status sensor assembly 20 detects an unusual condition, such as the presence of an unknown object between the automobile 68 and the apparatus 10 or that the rear door 74 is open, the control system 22 may generate an alarm signal to indicate such and/or the assembly line 66 may be stopped.

It should be understood that the first and second door status sensors 58 and 60 may be used to determine the position of the front door 72 relative to the body 70 of the automobile by measuring the distance to the closed rear door 74, or another portion of the automobile 68, such as the body 70. It should also be understood that the apparatus 10 may be configured to test doors on both sides of the automobile, as well as both forward-opening doors and rearward opening doors (e.g., the rear door 74). As such, several such apparatuses 10 may be positioned on each side of the assembly line 66 to test all of the doors on the automobile.

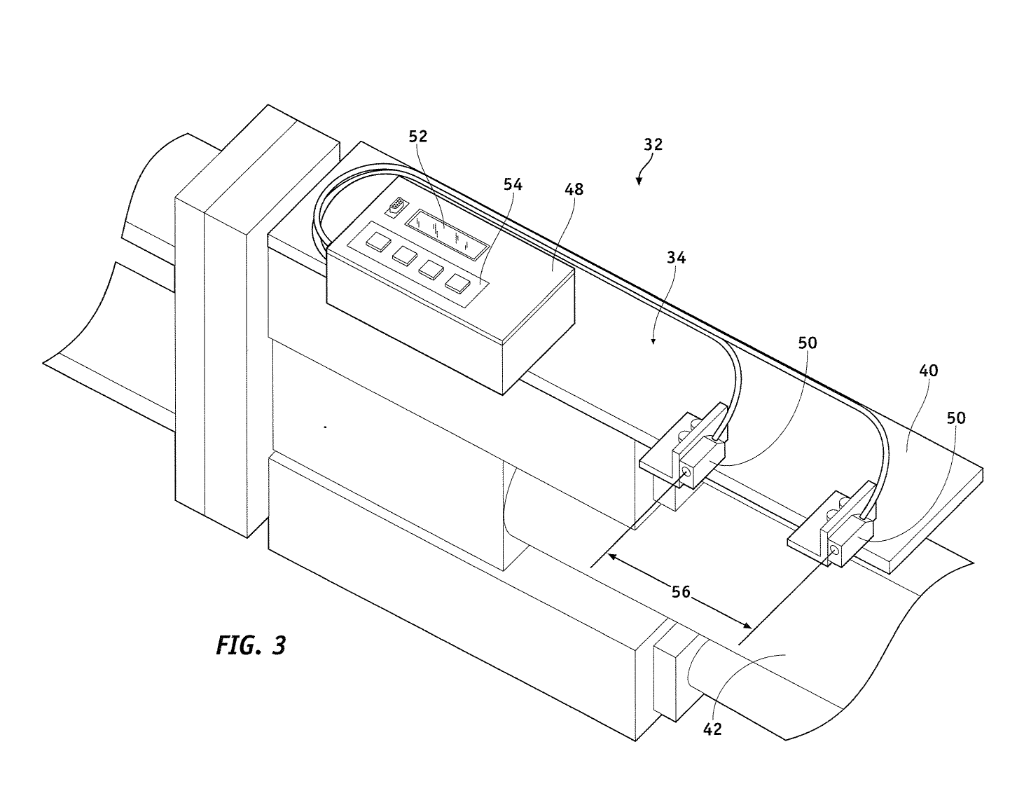

In the event that the type or model of automobile is changed, a user may enter information into the actuator controller 48 via the user input interface 54 (FIG. 3), which may include, for example, a series of key strokes for inputting data or for selecting particular settings from a menu displayed on the display device 52. Items on the menu may include, for example, a selection of characteristics or standards (i.e., maximum allowable door-closing velocities) or vehicle types stored in memory that a user may select depending on the particular vehicle door (e.g., make/model of vehicle) being tested. As such, a wide variety of automobiles may readily be tested using the apparatus 10.

One advantage is that the apparatus automatically determines whether or not the door of the automobile was completely closed by the movement of the door-closing member. As a result, the amount of human supervision is reduced, which reduces manufacturing costs. Another advantage is that the sensor array on the actuator allows the actual velocity at which the door is being closed to be monitored and appropriately adjusted for the particular automobile being tested.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. An apparatus for measuring a closing velocity of a door of a vehicle having a body, the apparatus comprising:
a base;
a door-closing member movably coupled to the base;
an actuator coupled to the base and the door-closing member and configured to move the door-closing member, the movement of the door-closing member causing the door of the vehicle to move relative to the body of the vehicle at a predetermined velocity; and
a sensor assembly coupled to the base and configured to detect a position of the door of the vehicle relative to a selected portion of the vehicle and generate a signal representative thereof.

2. The apparatus of claim 1, wherein the position of the door of the vehicle relative to the body of the vehicle is one of a first position and a second position.

3. The apparatus of claim 2, wherein the first position is indicative of the door of the vehicle being completely closed and the second position is indicative of the door of the vehicle being at least partially opened.

4. The apparatus of claim 1, wherein the sensor assembly is configured to measure a first distance between the sensor assembly and the selected portion of the vehicle and a second distance between the sensor assembly and the door of the vehicle.

5. The apparatus of claim 4, wherein a difference between the first distance and the second distance being greater than a predetermined threshold is indicative of the door of the vehicle being in the second position.

6. The apparatus of claim 2, wherein the sensor assembly is configured to detect the position of the door after the movement of the door, and further comprising a controller in operable communication with the sensor assembly, the controller being configured to receive the signal representative of the position of the door and generate an alert in response to the door being detected to be in the second position.

7. The apparatus of claim 6, further comprising a second sensor assembly coupled to the base and in operable communication with the controller, the second sensor assembly being configured to detect movement of the vehicle relative to the base from a first location to a second location and generate a second signal representative thereof.

8. The apparatus of claim 7, wherein the controller is further configured to receive the second signal from the second sensor assembly, actuate the actuator system when the vehicle is in the first location, and initiate the detection of the position of the door relative to the selected portion of the vehicle when the vehicle is in the second location.

9. The apparatus of claim 7, wherein the sensor assembly includes at least one ultrasonic sensor and the second sensor assembly includes at least one infrared sensor.

10. The apparatus of claim 7, wherein the second sensor assembly further comprises a vehicle position sensor coupled to the base and in operable communication with the controller, the vehicle position sensor being configured to detect when the door of the vehicle is within a predetermined distance of the door-closing member and generate a signal representative thereof, and wherein the controller is configured to actuate the actuator system when the vehicle is in the first location and the door is within the predetermined distance of the door-closing member.

11. An apparatus for measuring a closing velocity of a door of a vehicle having a body, the apparatus comprising:
a base;
a door-closing member movably coupled to the base;
an actuator coupled to the base and the door-closing member and configured to move the door-closing member;
a vehicle position sensor assembly coupled to the base and configured to detect a position of the vehicle relative to the base and generate a signal representative thereof,
a door position sensor assembly coupled to the base and configured to detect a position of the door of the vehicle relative to a selected portion of the vehicle and generate a signal representative thereof,
a controller in operable communication with the actuator, the vehicle sensor assembly, and the door position sensor assembly, the controller being configured to:
cause the actuator to move the door-closing member in response to the vehicle being in a first position relative to the base, the movement of the door-closing member causing the door of the vehicle to move at a predetermined velocity; and
generate an alert signal representative of the position of the door of the vehicle relative to the selected portion of the vehicle in response to the vehicle being in a second position relative to the base.

12. The apparatus of claim 11, wherein the detected position of the door of the vehicle relative to the selected portion of the vehicle is indicative of at least one of the door of the vehicle being completely closed the door of the vehicle being at least partially opened.

13. The apparatus of claim 11, wherein the door position sensor assembly is configured to measure a first distance between the door position sensor assembly and the selected portion of the vehicle and a second distance between the door position sensor assembly and the door of the vehicle, and wherein a difference between the first and second distances being greater than a predetermined threshold is indicative of the door of the vehicle being at least partially opened.

14. The apparatus of claim 11, wherein the vehicle position sensor assembly comprises a first sensor configured to detect a position of a wheel of the vehicle relative to the base and a second position configured to detect a position of the door relative to the base.

15. The apparatus of claim 11, wherein the vehicle position sensor assembly comprises at least one infrared sensor and the door position sensor assembly comprises at least one ultrasonic detector.

16. A method for measuring a closing velocity of a door of a vehicle having a body, the method comprising:
moving the vehicle between first and second positions;
automatically actuating a door-closing member during the movement of the vehicle when the vehicle is in the first position, the actuation of the door-closing member causing the door of the vehicle to move relative to the body of the vehicle at a predetermined velocity;
automatically detecting a position of the door of the vehicle relative to a selected portion of the vehicle during the movement of the vehicle when the vehicle is in the second position; and
generating a signal representative of the position of the door of vehicle relative to the selected portion of the vehicle after the vehicle is moved into the second position.

17. The method of claim 16, wherein the detecting of the position of the door of the vehicle relative to the selected portion of the vehicle comprises:
determining a first distance between a sensor assembly and the selected portion of the vehicle; and
determining a second distance between the sensor assembly and the door of the vehicle.

18. The method of claim 17, wherein if a difference between the first and second distances is greater than a predetermined threshold, the generated signal is indicative of the door being at least partially open.

19. The method of claim 18, further comprising detecting a position of the vehicle, the detecting of the position of the vehicle comprising detecting a position of at least one wheel of the vehicle.

20. The method of claim 19, wherein the determining of the first and second distances are performed with ultrasonic sensors and the detecting of the position of the at least one wheel of the vehicle is performed with an infrared sensor.
